(19) United States
(12) Patent Application Publication
(10) Pub. No.: US 2013/0333185 A1
(43) Pub. Date: Dec. 19, 2013

(54) UNIVERSAL REMOVABLE AND REUSABLE LIGHT HANGER AND METHOD OF USE THEREOF

(71) Applicant: James Adams, Ogden, UT (US)

(72) Inventor: James Adams, Ogden, UT (US)

(21) Appl. No.: 13/745,836

(22) Filed: Jan. 20, 2013

Related U.S. Application Data
(60) Provisional application No. 61/589,121, filed on Jan. 20, 2012.

(51) Int. Cl. F16M 13/02

(52) U.S. Cl. CPC F16M 13/02
USPC 29/428; 248/231.81

(57) ABSTRACT

A universal removable and reusable light hanger and method of use thereof wherein a device is described that will allow decorative outdoor lighting to be readily attached to outdoor structures on a temporary basis and readily removed.

### CROSS-REFERENCE TO RELATED APPLICATIONS

This application claims the benefit of U.S. Provisional Application No. 61589121 filed Jan. 20, 2012 in the United States Patent and Trademark Office which is hereby incorporated by reference herein in its entirety, including but not limited to those portions that specifically appear hereinafter, the incorporation by reference being made with the following exception: In the event that any portion of the above-referenced application is inconsistent with this

### RESEARCH OR DEVELOPMENT

Not Applicable.

### BACKGROUND OF THE INVENTION

1. The Field of the Invention

This disclosure relates generally to a removable and reusable hanger for decorative lights such as Christmas lights. Specifically, it relates to a universal reusable hanger for decorative lights, such as Christmas or other related holiday lights

2. Description of Related Art

Decorative outdoor lighting has long been popular, especially during holidays, such as Christmas. Outdoor lights are also popular at weddings, as well as social occasions that take place after dark. One problem inherent in outdoor lighting is that, until now, there existed no convenient way to attach the lights to outdoor structures, such as fences, and that do not involve using some sort of permanent or semi permanent attachment method such as take, screw, nails, thumb tacks, wire tires or staples. These types of attachment methods are inconvenient for temporary lighting applications like holiday lighting for the reason that they are time consuming both with regard to putting the lights up as well as with regard to taking the lights down. They also suffer from the problem of leaving permanent marks on the structures that have the effect of defacing the structures.

In addition, a cottage industry of hanging seasonal outdoor decorative lighting has grown up due to the popularity of seasonal outdoor lighting. For a price, companies will install, remove and in some cases store the decorative lights for the customer. If these installers had access to inexpensive, easy to use and readily reusable hangers for the outdoor lighting, they could be more efficient in plying their trade and everyone would benefit.

Thus, it would be useful to have a device that allowed for the easy and quick installation of outdoor lighting, that was temporary and readily reused. At least two impediments to this solution are the many different types of outdoor lights and the different sizes and shapes of the outdoor structures on which the lights are to be used. The types of outdoor lights commonly used include, but are not limited to: C2, C5, C7, C9, LED, Rope, icicle, and Net lights. One of the most common types of structures on which outdoor lights are placed are fences. Fences come in many different types that include, but are not limited to: vinyl privacy fences, vinyl rail fences, vinyl picket fences, chain link with rail fences, chain link fences, wood rail fences, grape stake fences, wood slat fences, pipe fences, steel frame fences, lattice fences and chicken wire fences. Because the different types of fences have potential attachment surfaces of different sizes and shapes, the challenge in creating a removable and reusable outdoor light hangers. Thus, it would be useful to have a removable and reusable outdoor light hanger that is simple in design and easy to use and is adaptable enough to work on a wide variety of fences.

Thus, it is an object of this invention to provide a removable and reusable hanger for outdoor lights.

It is a further object of this invention to provide a removable and reusable hanger for outdoor lights that can be used on many different outdoor applications, including many different types of fence surfaces.

It is a further object of this invention to provide a removable and reusable hanger for outdoor lights that do not make holes or otherwise leave some sort of permanent mark or change in the fence when they are removed.

### SUMMARY OF THE INVENTION

This disclosure relates generally to a removable and reusable hanger for decorative lights such as Christmas lights. Specifically, it relates to a universal reusable hanger to decorative lights, such as Christmas or other related holiday lights. It is an illustrative embodiment of the present invention to provide an easily used, easily removed and removable hanger for decorative lights. In the embodiment described herein, this device is designed to be readily installed on outdoor fences and is sufficiently adaptable in its size and shape to be readily installed on a wide variety of outdoor fences.

### BRIEF DESCRIPTION OF THE DRAWINGS

The features and advantages of the disclosure will become apparent from a consideration of the subsequent detailed description presented in connection with the accompanying drawings in which:

FIG. 1 is a perspective view of the light hanger;

FIG. 2 is a side view of the light hanger;

FIG. 3 is a perspective view of the light hanger installed on a chain link fence;

FIG. 4 is a perspective view of the light hanger installed on a vinyl fence;

FIG. 5 is a perspective view of the light hanger installed on a picket fence;

FIG. 6 is a top view of an embodiment of the hanger.

### DETAILED DESCRIPTION

At the outset, it should be appreciated that like drawing numbers on different views identify identical structure elements of the disclosure. While the present disclosure is described with respect to what is presently considered to be exemplary embodiments, it is understood that the disclosure is not limited to the disclosed embodiments.

Furthermore, it is understood that this disclosure is not limited to the particular methodology, materials and modifications described and as such may, of course, vary. It is also understood that the terminology used herein for the purpose of describing particular aspects only, and is not intended to limit the scope of the present disclosure, which is limited only by the appended claims.

Unless defined otherwise, all technical and scientific terms used herein have the same meaning as commonly understood to one of ordinary skill in the art to which this disclosure belongs. Although any methods, devices or materials similar or equivalent to those described herein can be used in the practice or testing of the disclosure, the preferred methods, devices, and materials are now described.

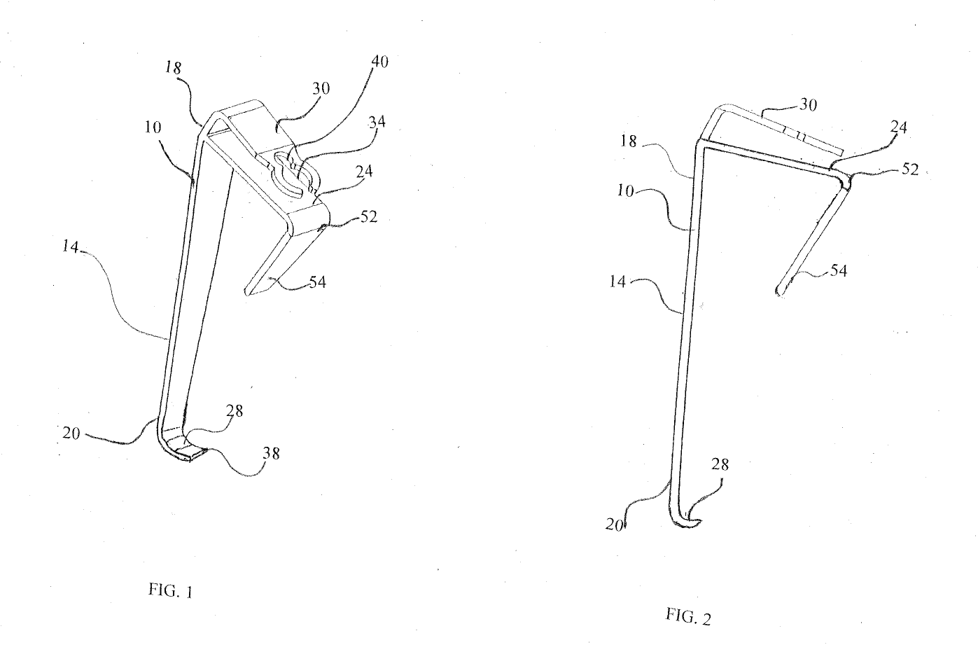

In accordance with one embodiment of the present invention, FIG. 1 depicts a perspective view of a universal removable and reusable light hanger [10]. As depicted in this embodiment, the light hanger [10] comprises a biased arm [14] having a first end [18] and a second end [20]. The biased arm [14] possesses a hook element [24] on its first end [18]. The biased arm [14] possesses a tail element [28] on its second end [28]. The hook element [24] also comprises a superstructure [30]. The superstructure [30] comprises at least one opening [34] sized and shaped to receive the base of an outdoor light fixture (not shown). In this embodiment, the superstructure comprises a second opening [40]. The first opening [34] is separately sized and shaped from the second opening [40]. The superstructure [30] may have a plurality of openings sized and shaped to receive any number of differently sized and shaped outdoor lighting fixtures or bulbs.

The universal removable and reusable light hanger [10] may also comprise an upturn [38] on its tail element [28]. This upturn would serve to engage certain structures on various types of fences and thus more fully engage the fence.

The universal removable and reusable light hanger [10] may be made of plastic, metal carbon fiber or any other material that can be suitable sized and shaped and possess the necessary biasing qualities. In the embodiment depicted in FIG. 1, the biased arm [14] has a length of between 4 and 10 inches. In this embodiment, the hook element [24] comprises a flat section [44]. As depicted here, the flat section [44] has a length of between 1 and 5 inches.

As depicted in FIG. 1, the hook element also possesses a recurve portion [48]. This recurve portion [48] trends toward the biased arm [14] such that a second end [54] of the recurve [48] is closer than a first and [52] of the recurve [48]. The recurve portion [48] is biased such that the hook element [24] can expand to fit fence rails of different sizes and diameters. In addition, the biased arm [14] possesses a taper in its width wherein its width is greater at its first end [18] than at its second end [20]. In addition, the recurve portion [48] of the hook element [24] possesses a taper in its width wherein its width is greater at its first [52] end than it is at its second end [54].

FIG. 2 is a side view of the light hanger 10. In this embodiment, the recurve portion 48 has a length of between 1 and 4 inches. In addition, the long axis of the said biased arm 14 and the long axis of the hook element 24 describe an angle of between 70 and 90 degrees. In addition, the long axis of the flat section 44 and the long axis of the recurve 48 describe an angle of between 65 and 90 degrees.

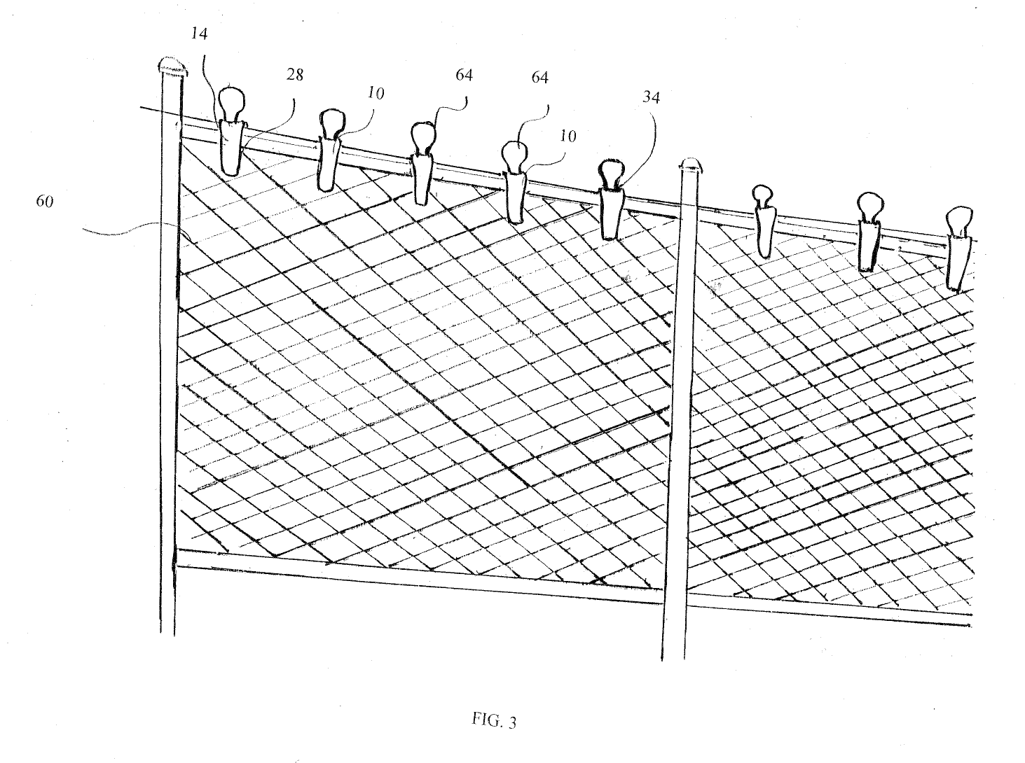

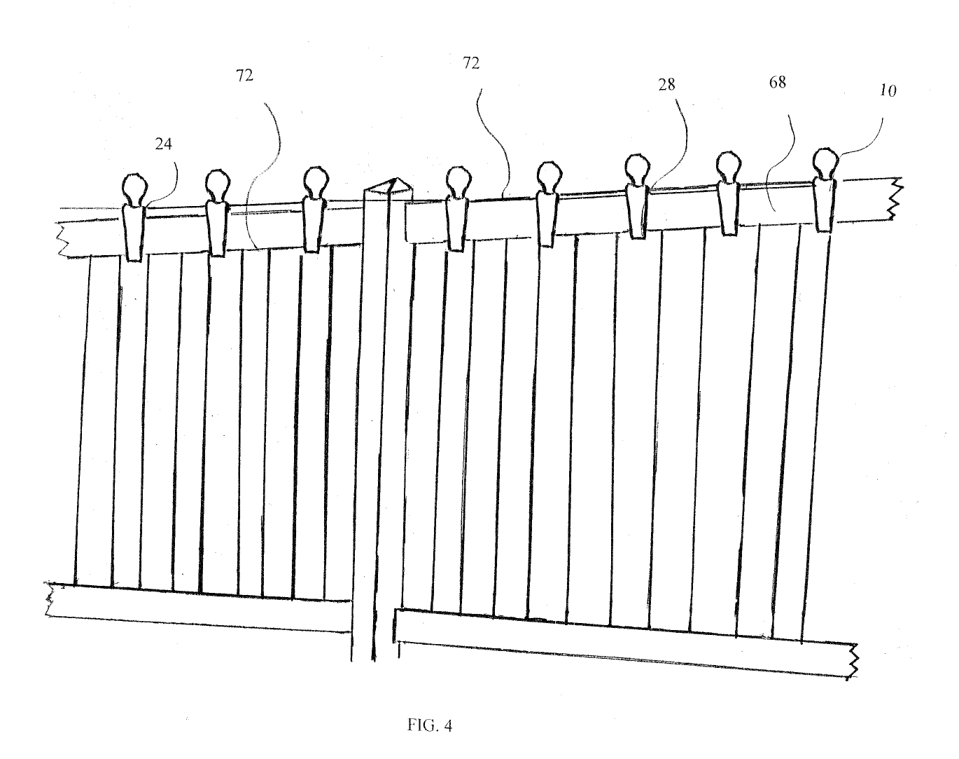

FIG. 3 depicts a method for using the universal removable and reusable light hanger [10] on a chain link fence [60] comprising the steps of (1) placing the said hook element of the said light hanger over the top rail of a chain link fence [60]; and (2) engaging a portion of the chain link of the fence with the tail element [28]. Because of the biasing action of the biased arm [14] and the recurve portion [48], the light hanger [10] is able to flex and by flexing, conform to the various sizes and shapes that the installer will encounter when placing the hanger on a chain link fence. Lights [64] are then attached to the hanger [10] by inserting the socket of the light into the opening [34] of the superstructure [30]. The opening comprises flexible material and is sufficiently biased that the opening [34] can flex to accept the socket and then via the biasing action of the opening [34] the opening [34] will hold the socket securely.

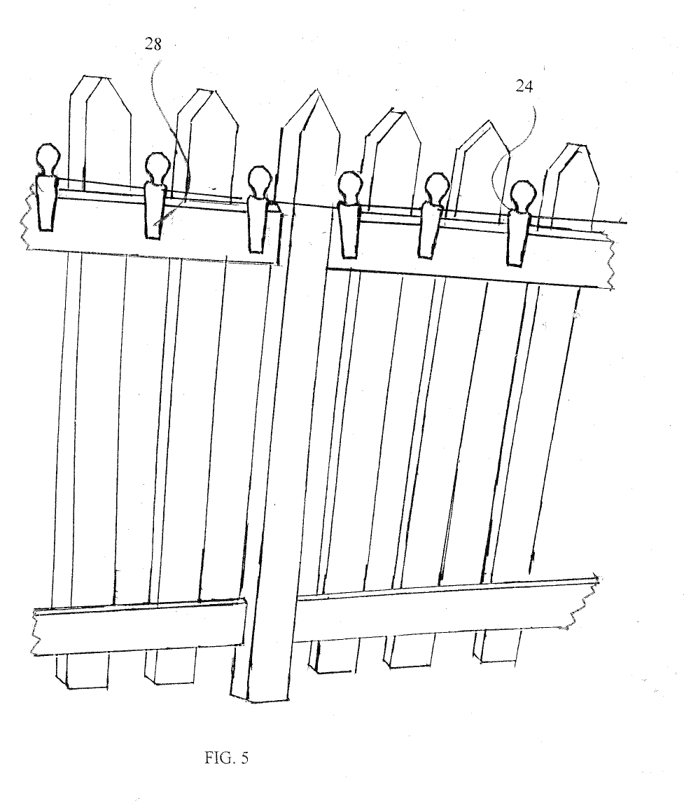

FIG. 4 depicts a method for using the universal removable and reusable light hanger on a vinyl fence [68] comprising the steps of (1) placing the hook element [24] of the light hanger over the top rail [72] of a vinyl fence [68]; and (2) engaging the bottom of the top rail [72] of the vinyl fence with the tail element [28]. The biasing action of the recurve [48] along with the shape of the hanger [10] whereby the recurve is closer to the biased arm [14] at the recurve's second end [54] than at the recurve's first end [52] allows the hanger [10] to conform to vinyl fence rails of various widths. An icicle type lighting device [76] is attached to the hanger [10] by hooking the strands of the icicle light within the superstructure [30].

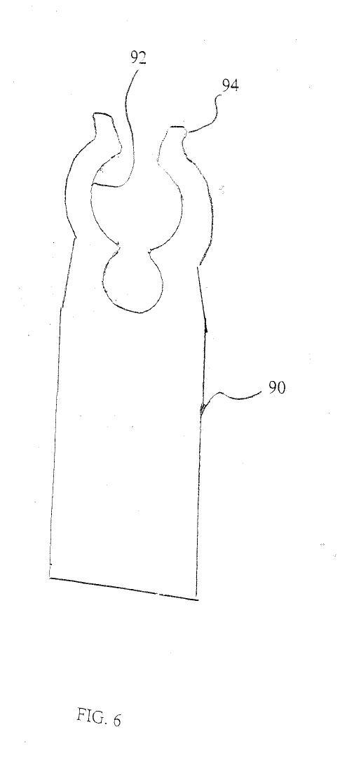

FIG. 5 depicts a method for using the universal removable and reusable light hanger [10] on a picket fence comprising the steps of (1) placing the said hook element [24] of the light hanger [10] over the top portion of the fence while sliding the said tail element [24] of the light hanger [10] over the top portion of the fence while sliding the said tail element [28] down the fence until the said hook element [24] rests on the top portion of the fence and the biasing action of the biased arm [14] squeezes the said fence between the tail element [28] and the hook element [24]. Rope lights [80] are attached by threading them between the hook element [24] and the superstructure [30].

In another embodiment, FIG. 6 depicts a top view of the superstructure [9] of a hanger in which a first opening [92] comprises a flare [94] to assist in inserting a light into the opening [92].

In another embodiment, the light strings are permanently attached to the hangers, such that they are installed and removed as one unit.

What is claimed is:

1. A universal removable and reusable light hanger comprising:
a biased arm having a first end and a second end;
said biased arm possessing a hook element on its first end;
said biased arm possessing tail element on its second end;
wherein the hook element comprises a superstructure; and
wherein the said superstructure comprises at least one opening sized and shaped to receive the base of an outdoor light fixture.

2. The universal removable and reusable light hanger of claim 1 further comprising an upturn on its tail element.

3. The universal removable and reusable light hanger of claim 1 wherein the said superstructure comprises a plurality of openings, with each opening being separately sized and shaped.

4. The universal removable and reusable light hanger of claim 2 wherein the said plurality of openings each correspond to a different sized outdoor light fixture.

5. The universal removable and reusable light hanger of claim 1 wherein the biased arm has a length of between 4 and 10 inches.

6. The universal removable and reusable light hanger of claim 1 wherein the said hook element comprises a flat section.

7. The universal removable and reusable light hanger at claim 6 wherein the said hook element flat section has a length of between 1 and 5 inches.

8. The universal removable and reusable light hanger of claim 6 wherein the said hook element possesses a recurve portion.

9. The universal removable and reusable light hanger of claim 8 wherein the recurve portion is biased.

10. The universal removable and reusable light hanger of claim 8 wherein the recurve portion has a length of between 1 and 4 inches.

11. The universal removable and reusable light hanger of claim 6 wherein the long axis of the said biased arm and the long axis of the said hook element describe an angle of between 70 and 90 degrees.

12. The universal removable and reusable light hanger of claim 6 wherein the long axis of the said biased arm and the long axis of the said hook element describe an angle of 80 degrees.

13. The universal removable and reusable light hanger of claim 1 wherein the said biased arm possesses a taper in its width wherein its width is greater at its first end than at its second end.

14. The universal removable and reusable light hanger of claim 13 wherein the recurve portion of the said hook element possesses a taper in its width wherein its width is greater at its first end than it is at its second end.

15. The universal removable and reusable light hanger of claim 1 wherein the said light hanger is comprised of plastic.

16. The universal removable and reusable light hanger of claim 1 wherein the said light hanger is comprised of plastic.

17. A universal removable and reusable light hanger comprising:
a biased arm having a first end and a second end;
said biased arm possessing a hook element on its first end;
said biased arm possessing a tail element on its second end;
wherein the hook element comprises a superstructure;
wherein the said superstructure comprises a plurality of openings separately sized and shaped to receive the base of different sized light fixtures;
wherein the tail element comprises an upturn;
wherein the biased arm has a length of between 4 and 10 inches;
wherein the hook element comprises a flat section;
wherein the hook element flat section has a length of between 1 and 5 inches;
wherein the hook element possesses a recurve portion;
wherein the recurve portion is biased;
wherein the recurve portion has a length of between 1 and 4 inches;
wherein the long axis of the biased arm and the long axis of the hook element describe an angle of between 70 and 90 degrees;
wherein the long axis of the biased arm and the long axis of the hook element describe an angle of 80 degrees;
wherein the biased arm possesses a taper in its width wherein its width is greater at its first end than at its second end;
wherein the recurve portion of the hook element possesses a taper in its width wherein its width is greater at its first end than it is at its second end;
wherein the said light hanger is comprised of plastic; and,
wherein the said light hanger is comprised of plastic.

18. A method for using the universal removable and reusable light hanger of claim 1 on a vinyl fence comprising the steps of:
placing the said hook element of the said light hanger over the top rail of a vinyl fence; and,
engaging a lower rail of the vinyl fence with the said tail element.

19. A method for using the universal removable and reusable light hanger of claim 1 on a solid wood fence comprising on a solid wood fence comprising the steps of:
placing the hook element of the light hanger over the top portion of the fence while sliding the tail portion down the fence until the hook element rests on the top portion of the said fence and the biasing action of the said biased arm squeezes the said fence between the tail portion of and the hook element.

20. A method for using the universal removable and reusable light hanger of claim 9 on a pipe fence comprising the steps of:
placing the hook end of the said light hanger over one of the horizontal rails of a pipe fence.
